(19) United States
(12) Patent Application Publication
(10) Pub. No.: US 2012/0119101 A1
(43) Pub. Date: May 17, 2012

(54) Miniature UV sensor utilizing a disposable flow cell

(75) Inventor: William H. Wynn, San Carlos, CA (US)

(73) Assignee: Endress + Hauser Conducta Gesellschaft fur Mess-und Regeltechnik mbH + Co. KG, Gerlingen (DE)

(21) Appl. No.: 12/926,362

(22) Filed: Nov. 12, 2010

(51) Int. Cl. G01J 1/42; G01N 23/10

(52) U.S. Cl. 250/373; 250/432 R

(57) ABSTRACT

An optical sensor is provided utilizing a disposable flow cell with a cell body, an inlet tube and an outlet tube providing a flow passageway extending between the inlet tube and the outlet tube through the cell body. The sensor comprises a first housing component comprising an open front end and a back end to which a removable light source is mounted and a second housing component comprising an open front end and a back end to which a light detector for detecting light emitted by the removable light source is mounted. The first and second housing components are detachably connected to one another, the open front ends of first and second housing components being tightly engaged to provide a sensor housing which accommodates and encloses the disposable flow cell. The light source and the detector are positioned at opposing sides of the cell body, an optical pathway extending along an axis between the light source and the detector through the cell body perpendicular to the flow passageway. The inlet tube and the outlet tube extend through apertures formed by corresponding recesses of the front ends of the first and the second housing component.

### FIELD OF INVENTION

This invention pertains generally to inline sensors and measurements and, more particularly, to a sensor utilizing a disposable flow cell comprising a light source, e.g. a solid state emitter for use in optical inline measurements, e.g. for measuring optical absorbance in the ultra violet (UV) spectral range, and a detector.

### RELATED ART

Inline optical measurements are used extensively in industrial applications, in particular in biotechnological and pharmaceutical applications. Known inline optical sensors comprise one or several light sources emitting a light beam of a certain wavelength range into a measuring cell, for example a flow cell carrying the medium to be monitored in a particular industrial application. Due to interaction with the medium optical effects like absorption, fluorescence or light scattering can occur. These effects can be used to determine a certain physical or chemical property of the medium to be monitored, such as for example the presence and/or the concentration of a certain chemical species in the medium or the turbidity of the medium. To this end, after passing through the measuring cell the light beam is directed towards a detector, which provides a signal depending on the impinging light intensity. From this signal the physical property of the medium to be monitored can be determined.

Biotechnological and pharmaceutical industrial processes often require sterile equipment. This includes any measuring equipment in contact with the process media. Nowadays many biotechnological or pharmaceutical industrial processes are carried out on a small scale with product yields of between about several liters and about several hundred liters. In order to avoid costly and complicated cleaning and sterilization treatments of process equipment in such processes it has become increasingly common to use disposable (i.e. single-use) process equipment, for example disposable reactors and tubing. Disposable equipment is normally made of plastic materials.

Heretofore, inline optical sensors for monitoring process media comprise a relatively complex structure that cannot easily be adapted to the aforementioned disposable process equipment or to laboratory or small-scale process conditions, respectively. There is a need to provide inline optical sensors utilizing a disposable flow cell in sterile applications, in particular in small-scale applications.

### OBJECTS AND SUMMARY OF THE INVENTION

It is the object of the invention to provide an improved sensor utilizing a disposable flow cell for use in inline sensor applications. It is applicable, for example, in biotechnological or pharmaceutical industrial processes or even for laboratory and small scale chromatographic separation and ultra filtration processes.

This object is achieved in accordance with the invention by providing an optical sensor utilizing a disposable flow cell, comprising:

the disposable flow cell comprising a cell body, an inlet tube and an outlet tube providing a flow passageway extending between the inlet tube and the outlet tube through the cell body,
a first housing component comprising an open front end and a back end to which a removable light source is removably mounted and a second housing component comprising an open front end and a back end to which a light detector for detecting light emitted by the light source is removably mounted,
wherein the first and second housing components are detachably connected to one another the open front ends of first and second housing component being tightly engaged to provide a sensor housing which accommodates and encloses the disposable flow cell,
and wherein the light source and the detector are positioned at opposing sides of the cell body, an optical pathway extending along an axis between the light source and the detector through the cell body perpendicular to the flow passageway, and
wherein the inlet tube and the outlet tube extend through apertures formed by corresponding recesses of the front ends of the first and the second housing component.

By providing two housing components, which, when their front ends are abuttingly engaged accommodate the flow cell, wherein the inlet tube and the outlet tube extend through apertures formed by corresponding recesses of the front ends, the flow cell can easily be removed and exchanged by simply detaching the housing components from each other.

The first housing component can comprise a first interior wall separating the light source from the flow cell and the second housing component can comprise a second interior wall separating the detector from the flow cell, the optical pathway between the light source and the light detector passing through transparent windows provided in the first and second interior wall.

The light source can comprise a solid state emitter emitting a monochromatic i.e. single wavelength light in the range of 240 to 400 nm and both the cell body and the windows can comprise one of UV transparent acrylic plastics, fused silica, and sapphire.

In a particular embodiment the optical sensor utilizing a disposable flow cell comprises:

a first housing component comprising a first end wall, an opposing second end wall and at least one side wall extending between the first and second end wall;
a second housing component comprising a first end wall, an opposing second end wall and at least one side wall extending between the first and second end wall;
the second end walls of the first and second housing component having a central aperture;
a removable light source assembly mounted to the first end wall of the first housing component;
a removable detector assembly mounted to the first end wall of the second housing component;
the disposable flow cell comprising a cell body, an inlet tube and an outlet tube providing a flow passageway through the cell body extending between the inlet tube and the outlet tube;
and wherein, when the second end walls of the first and second housing components are in abutting engagement,
the light source assembly is positioned opposite to and facing the detector assembly and an optical pathway extends along an axis between the light source assembly and the detector assembly passing through the central apertures of the first and second housing components; and
the first and second housing components accommodate the cell body and the inlet and outlet tube in a space formed by corresponding recesses in the second end walls of the first and second housing components, wherein the flow passageway runs substantially perpendicular to the optical pathway.

An optical window can be sealed into at least one of the central apertures of the second end walls of the first and second housing component, the optical window comprising a material that is transparent for light emitted by a light source of the light source assembly.

In another embodiment the first housing component comprises at least two parallel bores on opposite sides of the light source assembly extending parallel to the optical pathway in alignment with corresponding parallel bores in the second housing component, and wherein studs are mounted in the parallel bores, which extend through the engaged second end walls of the first and second housing component in order to fixedly connect the first and second housing component.

In yet another embodiment the first and second end walls of the first and second housing component are rectangular and four side walls extend between the first and second end walls, respectively, and wherein the first and second housing component comprises two parallel bores on opposite sides of the light source assembly extending parallel to the optical pathway through diagonally facing edges of the first and second housing component, and wherein the first and second housing component comprise two parallel blind bores extending parallel to the optical pathway from the second end wall through diagonally facing edges of the first housing component, wherein, when the second end walls of the first and second housing component are mated, the parallel bores of the first housing component are in alignment with the blind bores of the second housing component and the parallel bores of the second housing component are in alignment with the blind bores of the first housing component.

In this embodiment, in order to fixedly connecting the first and second housing components fasteners, in particular studs or screws, can be mounted in the parallel bores of the first housing component, which extend from outside the first housing component through the parallel bores of the first housing component into corresponding blind bores of the second housing component.

For example, the fasteners can have a portion protruding out of the first end walls of the first and second housing components and a head or a nut is attached to each portion for clamping the first and second housing components together.

In addition, both the first and second housing components can comprise a dowel pin extending from their second end walls which fit into corresponding mating holes in the second end walls, when the first and second housing components are engaged. This ensures accurate optical alignment of the optical detector and the light source, e.g. the solid state emitter.

The light source can comprise a solid state UV emitter for emitting light at a single wavelength in the range of 240 to 400 nm.

The cell body of the disposable flow cell comprises one of UV transparent acrylic plastics, fused silica, and sapphire.

In another embodiment the optical sensor utilizing a disposable flow cell comprises:

a light source and a detector, wherein the light source emits light along an optical pathway extending between the light source and the detector, the optical pathway passing through the disposable flow cell,
the disposable flow cell comprising:
a hollow cell body with two openings at opposite ends of the cell body,
and two line connectors each comprising an adapter portion mating with at least one of the openings of the cell body, the adapter portion being connected to the cell body in a fluid-tight manner.

The adapter portions of the line connectors each comprise a plate with a central aperture, and

wherein the central apertures, when the adapter portions are mated with the cell body, are positioned coaxially, and
wherein each connector further comprises a tube fixed to the plate in alignment with the aperture, the distal end of the tube providing a fitting for connecting the flow cell to a fluid line.

The hollow cell body can have a rectangular cross section and the plates can be rectangular as well.

The light source can comprise a solid state emitter emitting monochromatic light in the wavelength range of 240 to 400 nm and the hollow cell body can comprise one of UV transparent acrylic plastics, fused silica, and sapphire.

### BRIEF DESCRIPTIONS OF THE DRAWINGS

FIG. 1 is an isometric view of one embodiment of an inline optical sensor utilizing a disposable flow cell in accordance with the invention.

FIG. 2 is a sectional view of the embodiment of FIG. 1.

FIG. 3 is an exploded isometric view of the embodiment of FIGS. 1 and 2.

FIG. 4 shows a side elevational view (on the left side) and a front elevational view (on the right side) of a disposable flow cell for use in a sensor according to the embodiment of FIG. 1.

FIG. 5 is an exploded isometric view of a disposable flow cell for use in a sensor according to the embodiment of FIG. 1, with various possible adaptors for connecting the flow cell to various process lines.

### DETAILED DESCRIPTION

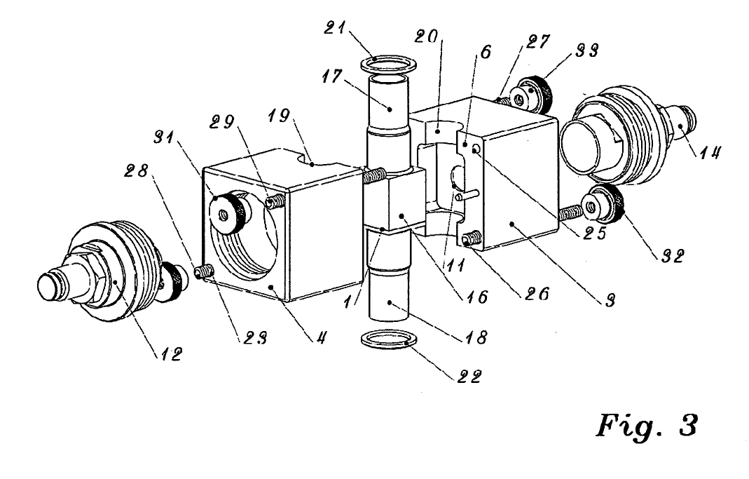

As illustrated in FIGS. 1 to 3 the optical sensor comprises a flow cell 1 which is accommodated in a housing comprising a first housing component 2 and a second housing component 3 of identical shape. Each housing component 2, 3 has a back end formed by a first end wall 4, 5. The first and second housing component 2, 3 have four side walls extending perpendicularly to the rectangular, in this example square, first end walls 4, 5. Opposite to the first end walls 4, 5 the housing components 2, 3 comprise second end walls 6, 7 in which a recess 8, 9 is formed. The second end walls 6, 7 each have a central aperture into which sapphire windows 10, 11 are sealed.

The sensor according to the exemplary embodiment of FIG. 1 to 3 has square end walls 4, 5. However, the end walls can be of any other shape, for example they can be circular. In this case, each housing component has only one tubular side wall, extending perpendicularly with respect to the circular end walls.

Into an internally threaded aperture formed in the first end wall 4 of the first housing component 2 an externally threaded receptacle 12 comprising a removable light source assembly is mounted. The light source assembly comprises a light source 13 and a printed circuit board carrying light source driver and/or light source control electronics. The light source can be a UV solid state emitter, for example.

The end wall 5 of the second housing component 3 comprises an internally threaded aperture identical to the aperture in the end wall 4 of the first housing component 2. To this threaded aperture an externally threaded receptacle 14 comprising a removable detector assembly is attached. The detector assembly comprises a detector 15 corresponding to the light source 13. In case the light source 13 is a UV solid state emitter, the detector can be a corresponding UV detector. Furthermore, the detector assembly can comprise one or more lenses which focus light emitted by the light source onto a sensitive surface of the detector 15. The detector assembly also comprises a printed circuit board carrying the detector electronics.

The receptacles 12, 14 are liquid tight and accept either quick disconnect or threaded cable assemblies. The pin configuration differs on each end to eliminate misconnecting. The receptacles 12, 14 can be fitted into the apertures of the end walls 4, 5 with O-ring seals to ensure environmental integrity.

To replace the light source or the detector, the receptacles 12 or 14 are unscrewed from their corresponding housing component. It is possible to remove the light source 13 or the detector 15, respectively, from the light source assembly or the detector assembly and to put a new light source or a new detector, respectively, in its place. Alternatively, the whole light source assembly or the whole detector assembly can be replaced by a new light source assembly or detector assembly. It is also possible to replace the complete receptacles 12 and 14.

Each receptacle 12, 14 comprises a circumferential shoulder which, when in abutting engagement with the end walls 4, 5 of the housing components 2, 3 fixes the receptacles 12, 14 in a predetermined position, thus ensuring correct optical alignment with a predetermined distance of the light source 13 from the detector 15.

The flow cell 1 comprises an essentially rectangular cell body 16, an inlet tube 17 and an outlet tube 18 both communicating with the cell body 16. The inlet tube 17 and the outlet tube 18 provide fittings that can be connected to various types of fluid pipes as will be described later.

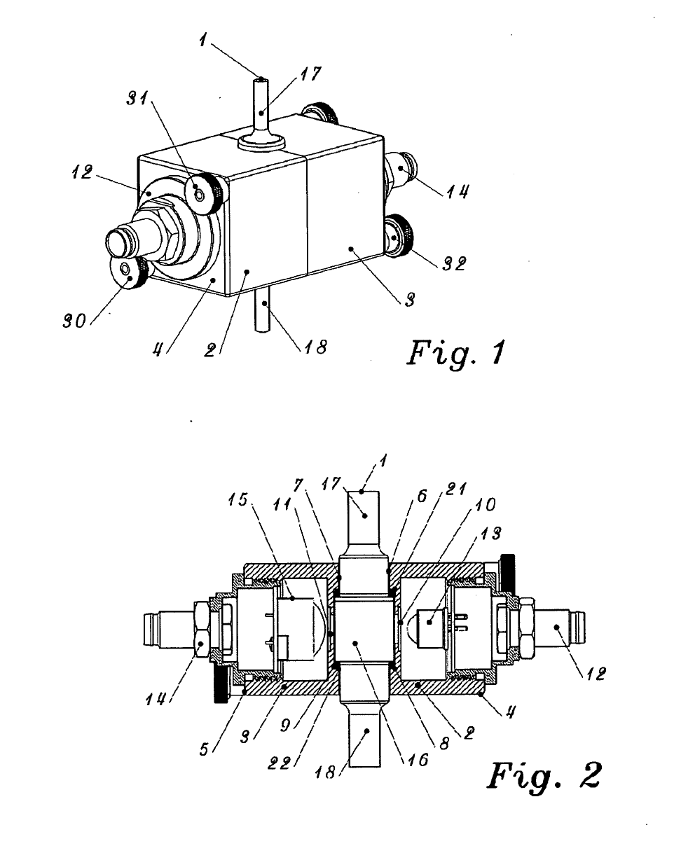

When the second end walls 6, 7 of the housing components 2, 3 are in abutting engagement, the recesses 8, 9 therein form an accommodation for the cell body 16. Opposite side walls of the housing components have semi-circular recesses 19, 20, which when the second end walls 6, 7 are in abutting engagement, form opposite circular openings in the side walls of the sensor housing through which extend the inlet tube 17 and the outlet tube 18 of the flow cell 1. As shown in FIGS. 1 and 2 the flow cell 1 is sealed against the side wall openings by means of O-ring seals 21, 22.

The light source 13 is positioned opposite and facing the detector 15 so that an optical pathway extends from the light source 13 through the sapphire windows 10, 11 and the cell body 16 to the detector 15. The flow passageway through the flow cell 1 runs substantially perpendicular to the optical pathway from the inlet tube 17 through the cell body 16 towards the outlet tube 18.

Each housing component 2, 3 comprises at least two clearance holes 23, 24 extending parallel to the optical pathway on opposite sides of the aperture for mounting the receptacle 12, 13. Advantageously, as shown in FIGS. 1 to 3, the clearance holes are positioned in diagonally facing edges of the housing components 2, 3. In addition, each housing component 2, 3 comprises two blind holes 25 extending parallel to the clearance holes 23, 24 from the second end wall 7, 8 into the side walls. In the embodiment according to FIGS. 1 to 3 the blind holes 25 are positioned in the remaining diagonally facing edges of the housing components 2, 3. Generally speaking, the blind holes 25 and the clearance holes 23, 24 are positioned in such a way, that when the first and second housing components 2, 3 are tightly engaged to form a closed sensor housing as described before, the clearance holes of the first housing component 2 are in alignment with the blind holes of the second component 3 and vice versa.

Through the clearance holes 23, 24 into the aligned blind holes extend four studs 26, 27, 28, 29. An end portion of each of the studs 26, 27, 28, 29 protrudes from the respective clearance hole out of the housing components 2, 3. In order to affix the housing components 2, 3 in a clamping manner thumb nuts 30, 31, 32, 33 are attached to these end portions.

In order to provide for correct alignment of the clearance holes 23, 24 and the blind holes 25 at least one dowel pin 34 and a mating hole are arranged on each housing component 2, 3 protruding from its second end wall 6, 7 in such a way that when the housing components 2, 3 are facing, the dowel pin of the first housing component 2 fits into the corresponding mating hole of the second housing component 3 and vice versa.

In another embodiment the housing components each have an end wall and side walls extending essentially perpendicularly from the corresponding end wall to an open front end of the housing component. The front ends of the side walls of each component can be brought in mating engagement with the corresponding side wall front ends of the other housing component in order to form an essentially closed sensor housing to accommodate the flow cell. In this case the light source assembly and the detector assembly are not separated from the flow cell by walls comprising an optical window. As in the embodiment shown in FIGS. 1 to 3, opposite side walls of the housing components have recesses, which, when the front ends of the housing components are in mating engagement, form opposite openings in the side walls of the sensor housing through which extend an inlet tube and an outlet tube of the flow cell. The sensor design according to this embodiment is even simpler than the sensor design according to the embodiment shown in FIGS. 1 to 3.

To replace the flow cell 1 the thumb nuts 30, 31, 32, 33 are detached from the studs 28, 29 and the flow cell 1 is made accessible by separating the housing components 2, 3 from each other. After removing the flow cell 1 a new flow cell can be accommodated between the housing components 2, 3 and the thumb nuts 30, 31, 32, 33 can be attached again to the studs 26, 27, 28, 29 in order to clamp the housing components 2, 3 together. Since the receptacles 12, 14 in which the light source 13 and the detector 15 are mounted do not have to be removed when the flow cell 1 is replaced, a re-alignment of the sensor optics is not necessary. When the sensor is online, only a simple re-zeroing is required to calibrate the measurement system.

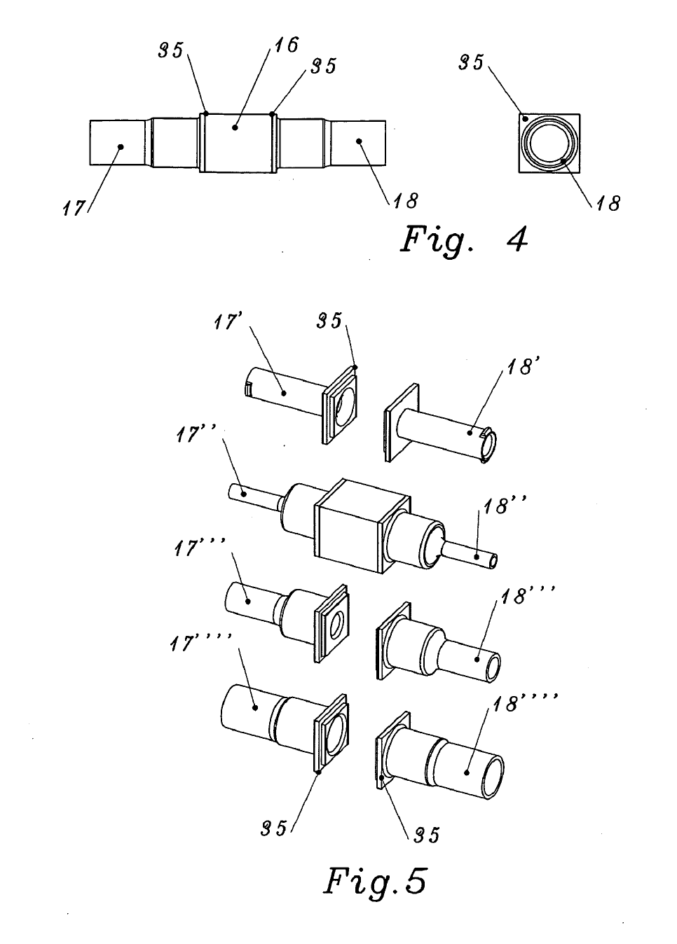

In FIGS. 4 and 5 the flow cell 1 is shown in more detail. As described before, the flow cell 1 comprises a cell body 16, an inlet tube 17 and an outlet tube 18 both communicating with the interior of the cell body.

The cell body and the inlet and outlet tube can be formed integrally. Alternatively, the inlet tube 17 and the outlet tube 18 can be detachably connected with the cell body 16. In this case it is possible to replace the inlet tube 17 and the outlet tube 18, respectively, by inlet tubes and outlet tubes with different dimensions or various fittings in order to adapt the flow cell 1 to various line and size connections. The inlet tube 17 and the outlet tube 18, respectively, can be fixed to a corresponding opening of the cell body 16 via an adapter portion 35. In the examples shown in FIG. 5 the adapter portion 35 is a rectangular plate with a circumferential shoulder which mates with a rectangular opening of the cell body 16 in such a way, that the adapter plate 35 forms a side wall of the rectangular flow cell 1. The rectangular plate 35 has a central aperture, which is tightly fixed to one end of the inlet tube 17 or the outlet tube 18, respectively. At their distal ends, the tubes 17, 18 are provided with fittings which can be connected to a particular fluid line which provides a fluid sample to be analyzed by the optical sensor. For example the fittings can be Luer fittings or hose barbs of various diameters, as shown in FIG. 5.

In an alternative embodiment, the flow cell body has a circular cross section and the adapter portion of the inlet and outlet tube can be a circular plate with a circumferential shoulder mating with a circular opening of the cell body.

The flow cell body alone or the complete flow cell can be made of a UV transparent material, such as for example fused silica, sapphire or UV transparent plastics, such as for example Acrylic plastics. A flow cell or a flow cell body made of UV transparent plastics can be injection molded. Injection molding is a particularly cost effective and flexible technology, which allows to provide a large variety of fittings for different kinds of fluid lines at reasonable costs.

The invention has a number of important features and advantages. The simple design with a minimum number of components allows for a small overall size of the sensor. For example, optical path lengths between 2 and 10 mm can be provided.

The optical design takes advantage of the UV solid state emitter light source and the detector being tightly coupled which increases the signal-to-noise ratio by orders of magnitude. This results in a significant increase in the optical density that can be measured. Solid state UV emitters also have many advantages, like fast turn-on characteristics attaining stable output. Moreover, UV solid state emitters are classified as intrinsically safe devices and therefore can be operated in hazardous environments with the use of safety barriers.

There can be instances when the application requires changing the operational wavelength of the sensor. In this instance, the light source receptacle can be unscrewed and replaced with another receptacle in which a light source of the desired wavelength is mounted. Alternatively, it is possible to unscrew the receptacle and to replace only the light source. In each case, the circumferential shoulder of the receptacle ensures that the receptacle is fixed in a predetermined position relative to the sensor housing and the detector assembly mounted to the sensor housing.

The flow cell can be sterilized using gas or radiation techniques which is common for system components that are in contact with the process stream. Since the flow cell can be easily mounted to the sensor, this sterilization process is ideal.

The construction of the sensor is designed to minimize the component count. The first and second housing components are identical and optimized to be fabricated by injection molding, which results in a significant cost reduction.

It is apparent from the foregoing that a new and improved optical sensor utilizing a disposable flow cell has been provided. While only certain presently preferred embodiments have been described in detail, as will be apparent to those familiar with the art, certain changes and modifications can be made without departing from the scope of the invention as defined by the following claims.

1. An optical sensor utilizing a disposable flow cell, comprising:
the disposable flow cell comprising a cell body, an inlet tube and an outlet tube providing a flow passageway extending between the inlet tube and the outlet tube through the cell body,
a first housing component comprising an open front end and a back end to which a removable light source is mounted and a second housing component comprising an open front end and a back end to which a light detector for detecting light emitted by the removable light source is mounted,
wherein the first and second housing components are detachably connected to one another the open front ends of the first and second housing components being tightly engaged to provide a sensor housing which accommodates and encloses the disposable flow cell,
and wherein the light source and the detector are positioned at opposing sides of the cell body, an optical pathway extending along an axis between the light source and the detector through the cell body perpendicular to the flow passageway, and
wherein the inlet tube and the outlet tube extend through apertures formed by corresponding recesses of the front ends of the first and the second housing components.

2. The optical sensor of claim 1, wherein:
the first housing component comprises a first interior wall separating the light source from the flow cell and the second housing component comprises a second interior wall separating the detector from the flow cell, the optical pathway between the light source and the light detector passing through transparent windows provided in the first and second interior wall.

3. The optical sensor of claim 2, wherein:
the light source comprises a solid state emitter emitting light in the wavelength range of 240 to 400 nm and both the cell body and the windows comprise one of UV transparent acrylic plastics, fused silica, and sapphire.

4. An optical sensor utilizing a disposable flow cell, comprising:
a first housing component comprising a first end wall, an opposing second end wall and at least one side wall extending between the first and second end wall;
a second housing component comprising a first end wall, an opposing second end wall and at least one side wall extending between the first and second end wall;
the second end walls of the first and second housing components having a central aperture;
a removable light source assembly mounted to the first end wall of the first housing component;
a removable detector assembly mounted to the first end wall of the second housing component;
the disposable flow cell comprising a cell body, an inlet tube and an outlet tube providing a flow passageway through the cell body extending between the inlet tube and the outlet tube;
wherein, when the second end walls of the first and second housing components are in abutting engagement,
the light source assembly is positioned opposite to and facing the detector assembly and an optical pathway extends along an axis between the light source assembly and the detector assembly passing through the central apertures of the first and second housing components;
the first and second housing components accommodate the cell body and the inlet and outlet tube in a space formed by corresponding recesses in the second end walls of the first and second housing components, wherein the flow passageway runs substantially perpendicular to the optical pathway.

5. The optical sensor of claim 4, wherein:
an optical window is sealed into at least one of the central apertures of the second end walls of the first and second housing components, the optical window comprising a material, that is transparent for light emitted by a light source of the light source assembly.

6. The optical sensor of claim 4, wherein:
the first housing component comprises at least two parallel bores on opposite sides of the light source assembly extending parallel to the optical pathway in alignment with corresponding parallel bores in the second housing component, and wherein studs are mounted in the parallel bores, which extend through the engaged second end walls of the first and second housing components in order to fixedly connect the first and second housing components.

7. The optical sensor of claim 4, wherein:
the first and second end walls of the first and second housing components are rectangular and four side walls extend between the first and second end walls, respectively,
and wherein the first and second housing components comprises two parallel bores on opposite sides of the light source assembly extending parallel to the optical pathway through diagonally facing edges of the first and second housing components, and wherein the first and second housing components comprise two parallel blind bores extending parallel to the optical pathway from the second end wall through diagonally facing edges of the first housing component,
wherein, when the second end walls of the first and second housing components are mated, the parallel bores of the first housing component are in alignment with the blind bores of the second housing component and the parallel bores of the second housing component are in alignment with the blind bores of the first housing component.

8. The optical sensor of claim 7, wherein:
for fixedly connecting the first and second housing components fasteners, in particular studs or screws, are mounted in the parallel bores of the first housing component, which extend from outside the first housing component through the parallel bores of the first housing component into corresponding blind bores of the second housing component.

9. The optical sensor of claim 8, wherein:
the fasteners having a portion protruding out of the first end walls of the first and second housing components and a head or a nut is attached to each portion for clamping the first and second housing components together.

10. The optical sensor of claim 4, wherein:
both the first and second housing components comprise a dowel pin extending from their second end walls which fit into corresponding mating holes in the second end walls, when the first and second housing components are engaged ensuring optical sensor alignment.

11. The optical sensor of claim 4, wherein:
the light source comprises a solid state UV emitter for emitting light at a single wavelength in the range of 240 to 400 nm.

12. The optical sensor of claim 4, wherein:
the cell body of the disposable flow cell comprises one of UV transparent acrylic plastics, fused silica, and sapphire.

13. An optical sensor utilizing a disposable flow cell, the optical sensor comprising:
a light source and a detector, wherein the light source emits light along an optical pathway extending between the light source and the detector, the optical pathway passing through the disposable flow cell,
the disposable flow cell comprising:
a hollow cell body with two openings at opposite ends of the cell body,
and two line connectors each comprising an adapter portion mating with at least one of the openings of the cell body, the removable adapter portion being connected to the cell body in a fluid-tight manner.

14. The optical sensor of claim 13, wherein:
the adapter portions of the line connectors each comprise a plate with a central aperture, and wherein the central apertures, when the adapter portions are mated with the cell body, are positioned coaxially, and
wherein each connector further comprises a tube fixed to the plate in alignment with the aperture, the distal end of the tube providing a fitting for connecting the flow cell to a fluid line.

15. The optical sensor of claim 14, wherein:
the hollow cell body has a rectangular cross section and the plates are rectangular.

16. The optical sensor of claim 13, wherein:
the light source comprising a solid state emitter emitting monochromatic light in the wavelength range of 240 to 400 nm and
the hollow cell body comprises one of UV transparent acrylic plastics, fused silica, and sapphire.
